(19) United States
(12) Patent Application Publication
(10) Pub. No.: US 2025/0173582 A1
(43) Pub. Date: May 29, 2025

(54) CREATING A UNIQUE FUNCTION IDENTIFIER USING DATAFLOW AND GRAPH EMBEDDING

(71) Applicant: INTERNATIONAL BUSINESS MACHINES CORPORATION, ARMONK, NY (US)

(72) Inventors: Shachee Mishra Gupta, Ghaziabad (IN); Douglas Lee Schales; Dhilung Hang Kirat, Hartsdale, NY (US); Jiyong Jang, Chappaqua, NY (US)

(21) Appl. No.: 18/520,753

(22) Filed: Nov. 28, 2023

(51) Int. Cl. G06N 5/02

(52) U.S. Cl. CPC G06N 5/02

(57) ABSTRACT

An approach is provided for creating dataflow-based function signatures. Using intermediate representations of application binaries of respective applications, functions included in the application binaries are extracted. Respective dataflows are generated for the extracted functions. Respective dataflow graphs are generated for the dataflows. The dataflow graphs are converted into respective sets of embeddings. A knowledge base in a data repository is populated with the sets of embeddings. Using a first similarity function, a second similarity function, and the populated knowledge base, it is determined that an unlabeled application binary matches one of the application binaries.

### BACKGROUND

The present invention relates to software security, and more particularly to creating dataflow-based function signatures.

As more and more applications are developed, the use of shared libraries and open source projects is increasing. Given an unknown application binary (i.e., executable binary), identifying the core and the shared libraries and functions used by the unknown application binary is important to a software security chain. A detected vulnerability in one application may be present in other related or unrelated applications that use a similar set of open source and dynamic libraries.

For applications built across multiple platforms, compilers and compiler optimization levels, the application binaries look significantly different from each other although they perform the same functionalities.

### SUMMARY

In one embodiment, the present invention provides a computer system that includes one or more computer processors, one or more computer readable storage media, and computer readable code stored collectively in the one or more computer readable storage media. The computer readable code includes data and instructions to cause the one or more computer processors to perform operations. The operations include, using intermediate representations of application binaries of respective applications, extracting functions included in the application binaries. The operations further include generating dataflows for the extracted functions, respectively. The operations further include generating dataflow graphs for the generated dataflows, respectively. The operations further include converting the dataflow graphs into respective sets of embeddings. The operations further include populating a knowledge base in a data repository with the sets of embeddings. The operations further include, using a first similarity function, a second similarity function, and the populated knowledge base, determining that an unlabeled application binary matches one of the application binaries.

A computer program product and a method corresponding to the above-summarized computer system are also described herein.

### BRIEF DESCRIPTION OF THE DRAWINGS

FIG. 1 is a block diagram of a system for creating dataflow-based function signatures, in accordance with embodiments of the present invention.

FIG. 2 is a block diagram of modules included in code included in the system of FIG. 1, in accordance with embodiments of the present invention.

FIG. 3 is a flowchart of a process of creating dataflow-based function signatures, where operations of the flowchart are performed by the modules in FIG. 2, in accordance with embodiments of the present invention.

FIG. 4 is an example of generating dataflow graphs in the process of FIG. 3, in accordance with embodiments of the present invention.

FIG. 5 is an example of converting a dataflow graph into a set of embeddings in the process of FIG. 3, in accordance with embodiments of the present invention.

FIG. 6 is an example of determining a measurement of similarity between functions by using a similarity function in the process of FIG. 3, in accordance with embodiments of the present invention.

FIG. 7 is a table of sample measurements of distances between functions using different compiler optimization levels, where the distances are determined by using a similarity function used in the process of FIG. 3, in accordance with embodiments of the present invention.

### DETAILED DESCRIPTION

### Overview

According to an aspect of the present invention, there is provided a computer system that includes one or more computer processors; one or more computer readable storage media; and computer readable code stored collectively in the one or more computer readable storage media, with the computer readable code including data and instructions to cause the one or more computer processors to perform at least the following operations: using intermediate representations of application binaries of respective applications, extracting functions included in the application binaries; generating dataflows for the extracted functions, respectively; generating dataflow graphs for the generated dataflows, respectively; converting the dataflow graphs into respective sets of embeddings; populating a knowledge base in a data repository with the sets of embeddings; and using a first similarity function, a second similarity function, and the populated knowledge base, determining that an unlabeled application binary matches one of the application binaries. A general technical effect of the aforementioned aspect of the invention is function signature creation using dataflows and embeddings. Specific technical effects of the aforementioned operation of determining that an unlabeled application binary matches one of the application binaries include predicting that a software vulnerability is present in an application, labeling a previously unlabeled application binary, and given a dataflow in one application, finding similar dataflows in other applications.

According to another aspect of the present invention, there is provided a computer-implemented method that includes the operations discussed above relative to the aspect of the invention that provides the computer system.

According to another aspect of the present invention, there is provided a computer program product that includes one or more computer readable storage media having computer readable program code collectively stored on the one or more computer readable storage media. The computer readable program code is executed by one or more processors of a computer system to cause the computer system to perform the operations discussed above relative to the aspect of the invention that provides the computer system.

The computer-implemented method and the computer program product each provide general and specific technical effects that include the general and specific technical effects discussed above relative to the aspect of the invention that provides the computer system.

In embodiments, the computer readable code including the data and the instructions causes the one or more processors to perform the determining that the unlabeled application binary matches one of the application binaries by performing at least the following operations: using the first similarity function, determining measurements of similarity between (i) sets of embeddings associated with an entirety of functions included in the unlabeled application binary and (ii) a set of embeddings included in the populated knowledge base; determining that each of the measurements of similarity does not exceed a threshold similarity measurement; and based on each of the measurements of similarity not exceeding the threshold similarity measurement, designating the set of embeddings included in the populated knowledge base as being dissimilar to each of the sets of embeddings associated with the entirety of functions included in the unlabeled application binary and preventing the designated set of embeddings included in the populated knowledge base from being placed in a subset of the populated knowledge base and from being further processed in an application of the second similarity function, which provides measurements of similarity between the unlabeled application binary and application binaries associated with sets of embeddings included in the subset of the populated knowledge base. A specific technical effect of the feature of designating the set of embeddings included in the populated knowledge base as being dissimilar to each of the sets of embeddings associated with the entirety of functions included in the unlabeled application binary and preventing the designated set of embeddings included in the populated knowledge base from being placed in a subset of the populated knowledge base and from being further processed in an application of the second similarity function provides a faster and more efficient determination of a match between application binaries by applying the second similarity function to a subset of the knowledge base rather than to the entire knowledge base. The feature serves to reduce the amount of data that is being processed by the second similarity function, which increases computational processing speed as a result. The operations discussed in this paragraph are also included in the aforementioned computer-implemented method and are performed by the computer system discussed relative to the aforementioned computer program product. The specific technical effects discussed in this paragraph are also specific technical effects provided by each of the aforementioned computer-implemented method and computer program product.

In embodiments, the computer readable code including the data and the instructions causes the one or more computer processors to perform the determining that the unlabeled application binary matches one of the application binaries by performing at least the following operations: using the first similarity function, determining a measurement of similarity between (i) a set of embeddings associated with a function included in the unlabeled application binary and (ii) a set of embeddings included in the populated knowledge base; determining that a measurement of similarity exceeds a threshold similarity measurement; and based on the measurement of similarity exceeding the threshold similarity measurement, designating the set of embeddings included in the populated knowledge base as being similar to the set of embeddings associated with the function included in the unlabeled application binary and placing the designated set of embeddings included in the populated knowledge base into a subset of the populated knowledge base, the subset of the populated knowledge base being permitted to be further processed in an application of the second similarity function, which provides measurements of similarity between the unlabeled application binary and application binaries associated with sets of embeddings included in the subset of the populated knowledge base. The feature of placing the designated set of embeddings into the subset of the populated knowledge base provides a specific technical effect of a smaller population of embeddings in which to search, thereby providing a specific technical effect of more efficient searches for matching application binaries. The operations discussed in this paragraph are also included in the aforementioned computer-implemented method and are performed by the computer system discussed relative to the aforementioned computer program product. The specific technical effects discussed in this paragraph are also specific technical effects provided by each of the aforementioned computer-implemented method and computer program product.

In embodiments, the computer readable code including data and instructions causes the one or more computer processors to capture information about a structure of a given dataflow graph included in the generated dataflow graphs while ignoring identifiers of nodes and identifiers of edges in the given dataflow graph. The capture of the aforementioned information includes capturing types of the nodes, types of the edges, total numbers of nodes of one or more of the types of the nodes, and total numbers of edges of one or more of the types of the edges. The converting of the dataflow graphs is based on the captured information about the structure of the given dataflow. Basing the conversion of the dataflow graphs on the captured information about the structure of the given dataflow graph while ignoring the identifiers of the nodes and the identifiers of the edges provides a specific technical effect of avoiding the complexities of creating embeddings from a dataflow graph in which multiple nodes have the same type of instruction. The operations discussed in this paragraph are also included in the aforementioned computer-implemented method and are performed by the computer system discussed relative to the aforementioned computer program product. The specific technical effect discussed in this paragraph is also a specific technical effect provided by each of the aforementioned computer-implemented method and computer program product.

In embodiments, the computer readable code including data and instructions causes the one or more computer processors to capture information about a structure of a given dataflow graph included in the generated dataflow graphs by generating, in a pattern rather than in a random order, identifiers of nodes and identifiers of edges in the given dataflow graph. The capture of the aforementioned information includes capturing type information about a head node and a tail node for a given edge included in the edges in the given dataflow graph and associating the type information about the head and tail nodes with a type of the given edge. The converting of the dataflow graphs is based on the captured information about the structure of the given dataflow. The feature of generating, in a pattern rather than in a random order, identifiers of nodes and identifiers of edges in the given dataflow graph provides the specific technical effect of avoiding unwanted merging of nodes whose types are the same in the given dataflow graph, which facilitates the creation of embeddings from the dataflow graph. The operations discussed in this paragraph are also included in the aforementioned computer-implemented method and are performed by the computer system discussed relative to the aforementioned computer program product. The specific technical effect discussed in this paragraph is also a specific technical effect provided by each of the aforementioned computer-implemented method and computer program product.

In embodiments, the first similarity function determines similarity measurements by employing a Jaccard distance and the second similarity function determines similarity measurements by employing a distance selected from the group consisting of a cosine distance, an L2-norm Euclidean distance, an L1-norm Manhattan distance, a dot product distance, and an extended Jaccard distance. The feature of employing the Jaccard distance with the first similarity function provides a specific technical effect of identifying dissimilar application binaries, which is not affected by false positives (i.e., false identification of similar application binaries) associated with employing the Jaccard distance. The feature of the second similarity function employing the distance selected from the aforementioned group, as compared to employing the Jaccard distance, provides a specific technical effect of extracting finer-grained similarities between application binaries while avoiding at least some of the false positive similarity identifications associated with the first similarity function. The features discussed in this paragraph are also included in the aforementioned computer-implemented method and the operations performed by the computer system discussed relative to the aforementioned computer program product. The specific technical effects discussed in this paragraph are also specific technical effects provided by each of the aforementioned computer-implemented method and computer program product.

In embodiments, the computer readable code including data and instructions causes the one or more computer processors to generate, using a given set of embeddings converted from a given dataflow graph generated for a given dataflow for a given function, a dataflow-based signature of the given function. The given dataflow specifies data flowing into variables and registers and being passed to and returned from other functions. The feature of generating the dataflow-based signature of the given function provides the specific technical effect of identifying the given function at a fine-grained scale, which avoids the coarse-grained scale of control flow graph-based function identification that is limited to encapsulating only information about an execution of the function. The features discussed in this paragraph are also included in the aforementioned computer-implemented method and the operations performed by the computer system discussed relative to the aforementioned computer program product. The specific technical effect discussed in this paragraph is also a specific technical effect provided by each of the aforementioned computer-implemented method and computer program product.

A particular application of an embodiment of the present invention can include using the computer-implemented method described above to predict a software vulnerability. For example, a computer-based software security system being employed in a software security chain detects a vulnerability in one application that includes a particular set of open source components and dynamic libraries. Given that sharing open source components and dynamic libraries among different applications is prevalent, the software security system attempts to find whether the detected vulnerability is present in any other applications. The computer-implemented method includes the software security system determining that an unlabeled application binary matches the application binary of the application that has the previously detected vulnerability. The match is determined by initially using a coarse-grained first similarity function to filter out sets of embeddings in a knowledge base that are identified as being dissimilar to a set of embeddings that specify the application binary of the application whose vulnerability was previously detected. The first similarity function performs this filtering out with a high degree of certainty. The software security system subsequently uses a finer-grained second similarity function applied to only that proper subset of the knowledge base that has not been identified as being dissimilar by the first similarity function. The software security system employs the second similarity function to identify one of the sets of embeddings in the proper subset of the knowledge base which is a match to the set of embeddings associated with the application whose vulnerability was detected. In response to identifying one of the sets of embeddings as being a match, the software security system predicts that the application associated with the identified set of embeddings has the same vulnerability as the application whose vulnerability was previously detected. This usage of the proper subset of the knowledge base reduces the amount of data that needs to be processed by the software security system employing the second similarity function, thereby increasing computation speed overall. Another particular application of an embodiment of the present invention can include using the computer-implemented method described above to label an unnamed (i.e., unlabeled) application binary. The computer-implemented method includes extracting functions included in the unnamed application binary, generating dataflows for the extracted functions, respectively, generating dataflow graphs for the generated dataflows, respectively, converting the dataflow graphs into respective sets of embeddings, determining that the sets of embeddings for the unnamed application binary match sets of embeddings included in the knowledge base, where the sets of embeddings included in the knowledge base are associated with a labeled application binary, which is identified by an identifier. Based on the match, the computer-implemented method outputs the aforementioned identifier and assigns the identifier as the label for the unnamed application binary.

Hashing is used in conventional methods of identifying the core and shared libraries and functions used by a given unknown application binary. The conventional methods create a hash of the current application binary and match the hash to a precalculated set of hashes. Although straightforward and intuitive, the aforementioned conventional methods fail to identify an existing match in a number of cases. The application binary generated from the same set of statements from a source code can have different representations in binary format depending on the optimization levels of a compiler and the architecture for which the compiler was built. In these situations, the conventional hash-based technique is not able to identify a function even if its corresponding functions are available in a database.

Embodiments of the present invention address the aforementioned unique challenges by developing a dataflow-based application identifier or function identifier (i.e., dataflow-based application signature or dataflow-based function signature) approach that uses embeddings, which is based on the flow of data within an application or function staying the same to serve the same functionality, irrespective of the architecture, compiler, or compiler options (i.e., compiler optimization levels). The dataflow-based approach exploits the dataflow of functions included in an application staying the same, even though the application is built using multiple compilers across different architectures and using different compiler options, and even though the control flow of the functions may differ across the different compilers, architectures, and compiler options (e.g., as a result of inlining, constant propagation, etc.). The dataflow-based approach is further based on the input arguments traversing a same set of instructions as operand and eventually resulting in a return value. Embodiments of the present invention provide dataflow-based application signatures or dataflow-based function signatures, which provides techniques for (i) finding similar dataflows in other applications or functions, (ii) labelling unnamed application binaries, and (iii) finding vulnerabilities in applications.

Embodiments of the present invention provide a system and method that (i) receive an application binary and a function identifier (i.e., function name) as input, (ii) extract fine-grained dataflow information from within the function, (iii) represent the dataflow as a graph, (iv) convert the graph into a form of graph embeddings (i.e., encode the graph in a vector format), (v) use the graphs to create a knowledge base, and (vi) using the knowledge base, identify functions implementing similar operations across multiple executables. The fine-grained extraction of dataflow information includes a capture of information about multiple flows at the same time, and further includes a capture of information about data flowing into variables, registers, and being passed to and being returned from other functions. The fine-grained extracted dataflow information is the basis for the dataflow-based function signature. Using the graph embeddings to represent the graph in the knowledge base facilitates faster searches and optimized storage.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

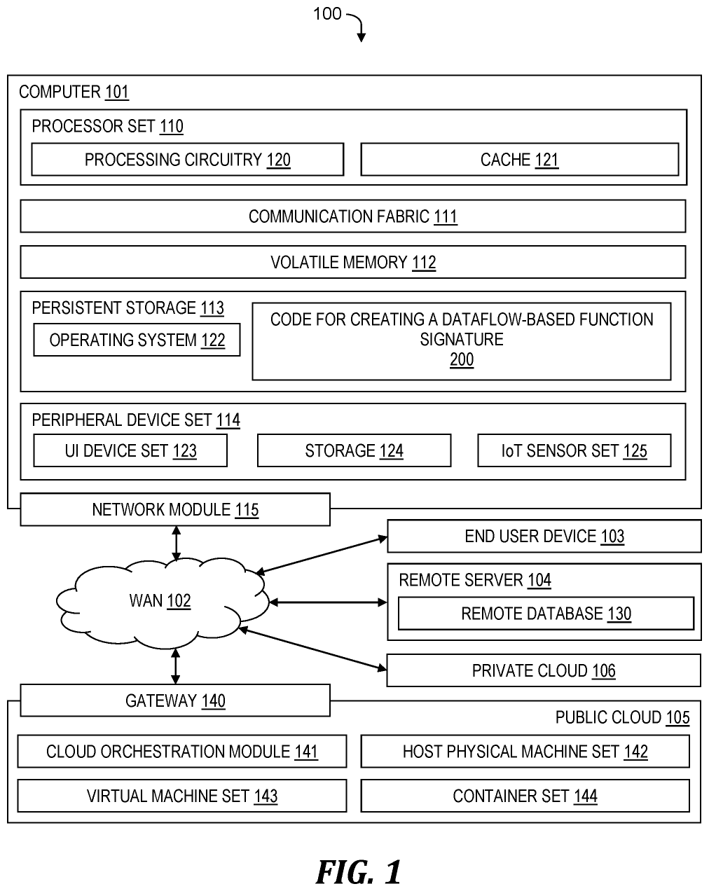

FIG. 1 is a block diagram of a system for creating dataflow-based function signatures, in accordance with embodiments of the present invention. Computing environment 100 contains an example of an environment for the execution of at least some of the computer code involved in performing the inventive methods, such as code 200 for creating a dataflow-based function signature. The aforementioned computer code is also referred to herein as computer readable code, computer readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### System and Process for Creating a Dataflow-Based Function Signature

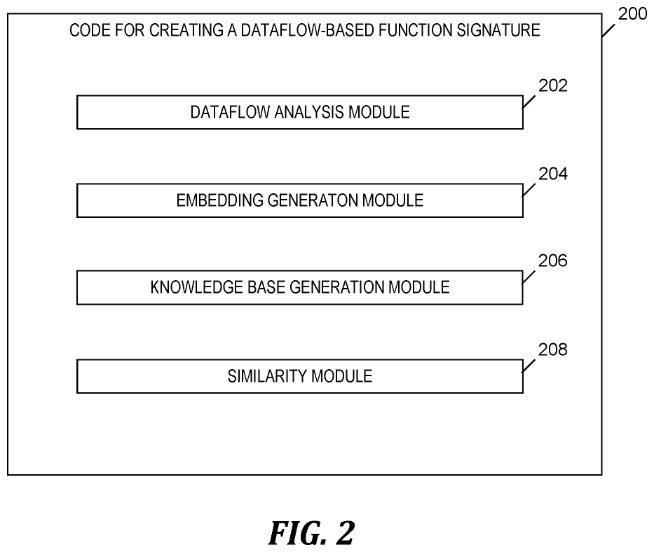

FIG. 2 is a block diagram of modules included in code 200 included in the system of FIG. 1, in accordance with embodiments of the present invention. Code 200 includes a dataflow analysis module 202, an embedding generation module 204, a knowledge base generation module 206, and a similarity module 208.

Dataflow analysis module 202 is configured to receive an input of an application binary and lift the application binary to an intermediate representation (IR) by using lifting tools, such as, for example, McSema or RetDec tools, and to extract functions from the IR. McSema is an executable lifter that translates (i.e., lifts) executable binaries from native machine code to LLVM bitcode, which is an IR of a software program. RetDec is a retargetable machine code decompiler based on LLVM bitcode. LLVM refers to a set of compiler and toolchain technologies, originally stood for Low Level Virtual Machine, but is no longer officially an acronym. Dataflow analysis module 202 is further configured to process the lifted IR to extract dataflow information by using LLVM utilities such as llvm-dis and llvm-opt. The llvm-dis utility is the LLVM disassembler and the llvm-opt utility is the modular LLVM optimizer. Dataflow analysis module 202 is further configured to perform dataflow analysis on a per function level by extracting fine-grained dataflow information from the extracted functions and determine and generate respective dataflows for the extracted functions. Dataflow analysis module 202 is further configured to generate respective dataflows for the extracted functions and to generate dataflow graphs for the generated dataflows, respectively. Thus, dataflow analysis module 202 generates a dataflow graph for each function (i.e., generates a dataflow graph specifying a function-application binary pair), where the function arguments have no incoming edge in the dataflow graph, while the return instruction terminates the dataflow graph. Each node in a dataflow graph can be an instruction or an argument to an instruction. Dataflow analysis module 202 is further configured to provide user interface mockups that visualize dataflow graphs and allow human operators to inspect visualizations of dataflow graphs and inspect how similar one dataflow graph is to another dataflow graph.

Embedding generation module 204 is configured to use a machine learning-based method to create an embedding representation for each of the function-application binary pair graphs generated by data analysis module 202. That is, embedding generation module 204 is configured to convert the dataflow graphs generated by the dataflow analysis module 202 into respective sets of embeddings. In one embodiment, embeddings are low-dimensional representations of entities and relations in dataflow graphs. Embeddings are also referred to herein as graph embeddings. Alternatively, embedding generation module 204 uses the machine learning-based method to convert the dataflow graphs into respective feature vector representations, which are used to create the dataflow-based application signatures or function signatures.

The dataflow graphs generated by dataflow analysis module 202 include a significant amount of information for each function, including information about the input arguments, instructions, the flow of data, etc. A given dataflow graph generated by dataflow analysis module 202 includes labeled edges and node types. For example, a given function can have multiple “add” instructions and in the dataflow graph for the given function, each of the nodes representing the “add” instruction has the same type but different identifiers (IDs). Similarly, for edges in the dataflow graph for the given function, an edge can be carrying, for example, a value of type i64, i64*, etc., each of which is an edge type. Thus, in this example, the dataflow graph for the given function takes the form of a heterogeneous graph. There are complications associated with creating feature vectors for heterogeneous graphs. The node type and edge type information cause a complexity in creating embeddings for heterogeneous graphs. For instance, if there are two nodes in a graph that are of the type “add” instruction, then the two nodes cannot be represented by their types; otherwise, the two nodes are merged. The IDs of the nodes are randomly generated values, which do not conform to a specific pattern. The graphs in this example could be two isomorphic graphs, but because of the difference in node IDs, the associated feature vectors are different. Thus, there is a need for the embedding generation module 204 to capture the structure information of a dataflow graph while ignoring the node IDs and edge IDs.

In one embodiment, embedding generation module 204 is configured to capture structure information of a dataflow graph by considering the dataflow graph in terms of the type of nodes (i.e., entities) and types of edges (i.e., relations). This consideration changes the structure of the dataflow graph, but the information about the number of nodes and edges of certain types remains intact. Alternatively, embedding generation module 204 is configured to capture structure information of a dataflow graph by using the IDs of the nodes and edges, but instead of generating the IDs in a random order, embedding generation module 204 assigns a pattern and generates the IDs of the nodes and edges in the assigned pattern. In this alternative configuration, for a given edge, embedding generation module 204 includes type information of a head node and a tail node of the given edge in the edge “type” in order to capture additional information. With these changes in the alternative configuration, embedding generation module 204 generates multiple representations of a given dataflow graph.

Embedding generation module 204 represents a given dataflow graph for a function in the form of triples, which are input into an embedding algorithm included in embedding generation module 204. For example, an edge in the dataflow graph, a source node of the edge, and a final node of the edge is represented as a triple that includes an edge weight, an ID of the source node, and an ID of the final node. In one embodiment, embedding generation module 204 uses an existing tool, such as graph2vec, to generate the feature vectors that represent the given dataflow graph. In another embodiment, embedding generation module 204 uses a mature tool, such as Deep Graph Learning (DGL) to generate the feature vectors that represent the given dataflow graph.

In one embodiment, embedding generation module 204 is configured to use a score function, such as TransE, to create feature vectors for each node and edge in a dataflow graph. In one embodiment, embedding generation module 204 aggregates node and edge types to create a feature vector representing a given function.

Knowledge base generation module 206 stores the sets of embeddings generated by embedding generation module 204 into a knowledge base. The knowledge base is also referred to herein as a knowledge graph. The sets of embeddings being stored in the knowledge graph allow for an optimal search of the knowledge graph for a set of embeddings representing an application binary that matches a set of embeddings that represent an inputted application binary.

Similarity module 208 is configured to (i) receive an unlabeled application binary, (ii) employ the dataflow analysis module 202 and the embedding generation module 204 to process the unlabeled application binary by extracting functions included in the unlabeled application binary, generating dataflows for the extracted functions, generating dataflow graphs for the generated dataflows, and generating sets of embeddings for the unlabeled application binary by converting the generated dataflow graphs into respective sets of embeddings, and (iii) find application binaries that are most similar to the unlabeled application binary by using a method that includes first and second levels of similarity determinations.

The first level of similarity determination operates at a function level using a relatively simple technique for finding measurements of similarities between application binaries. In one embodiment, the first level of similarity determination includes a first similarity function calculating Jaccard distances between first and second dataflow graphs. Before calculating a final Jaccard distance, similarity module 208 determines an initial similarity calculation between the first and second dataflow graphs, which is the count of the number of elements (i.e., IDs of nodes and IDs of edges) that the first and second dataflow graphs have in common divided by a count of the number of unique elements that are included in the first and second dataflow graphs (i.e., the intersection of the elements in the dataflow graphs divided by the union of the elements in the dataflow graphs). The Jaccard distance is then calculated as one minus the aforementioned initial similarity calculation. For comparison between two Jaccard distances, a smaller value indicates a smaller distance, which in turn indicates a greater similarity between the corresponding dataflow graphs. Although the Jaccard distance can result in a false positive (i.e., a false indication that two dataflow graphs are similar based on the Jaccard distance not exceeding a predefined threshold similarity measurement), similarity module 208 uses the Jaccard distance to indicate dissimilarity between dataflow graphs (i.e., based on the Jaccard distance exceeding the predefined threshold similarity measurement) and rule out the dissimilar cases from being further processed by the second level of similarity determination. That is, similarity module 208 identifies the parts of the knowledge base that are certainly not similar to the unlabeled application binary and prevents those parts from being further processed.

The second level of similarity determination uses a combined similarity match that considers an entirety of the feature vectors or sets of embeddings from the unlabeled application binary. This second level of similarity determination operates by a second similarity function extracting finer-grained similarities (as compared to the first level of similarity determination) by calculating one of the following distances between dataflow graphs: a cosine distance, an L2-norm Euclidean distance, an L1-norm Manhattan distance, a dot product distance, or an extended Jaccard distance.

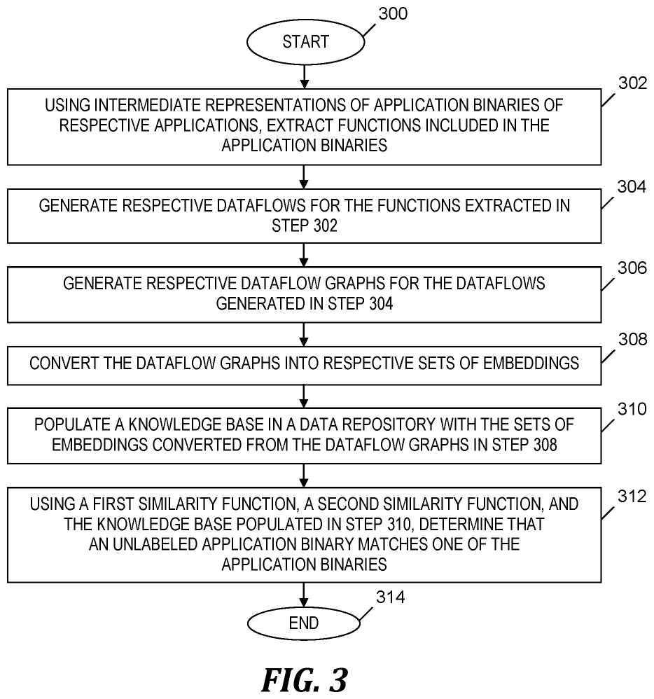

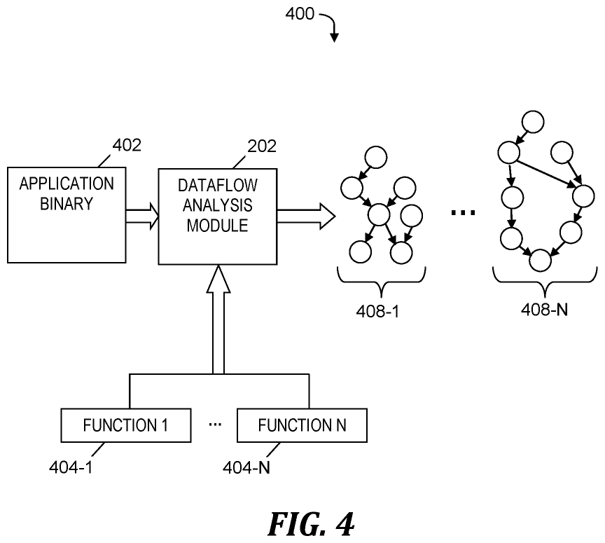

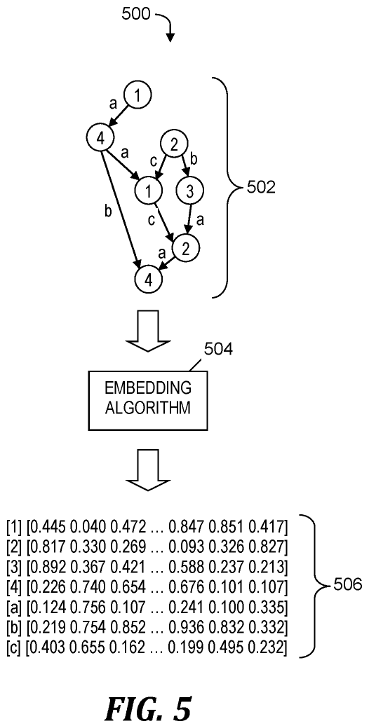

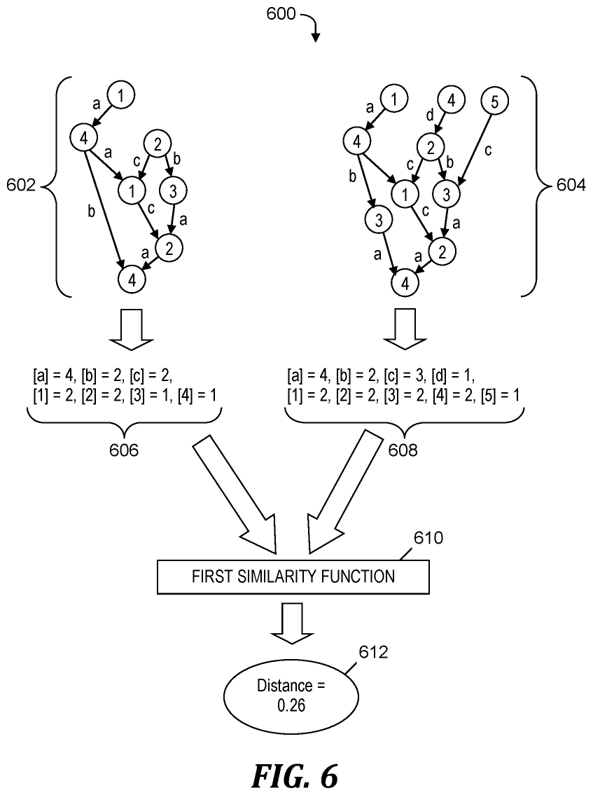

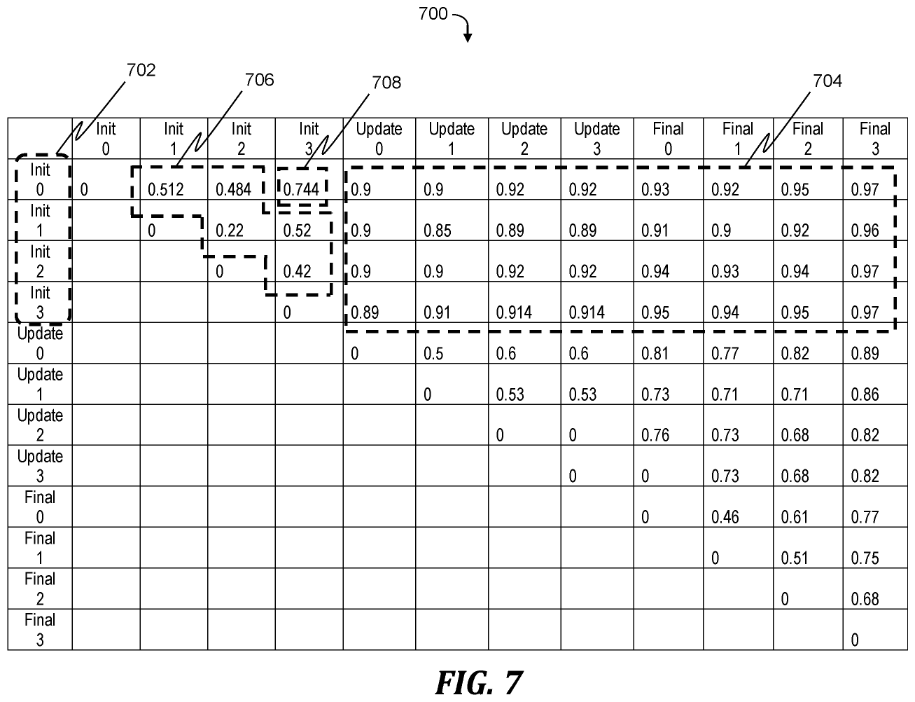

The functionality of the modules included in code 200 is described in more detail in the discussions presented below relative to FIG. 3, FIG. 4, FIG. 5, FIG. 6, and FIG. 7.

FIG. 3 is a flowchart of a process of creating dataflow-based function signatures, where operations of the flowchart are performed by the modules in FIG. 2, in accordance with embodiments of the present invention. The process of FIG. 3 begins at a start node 300. Prior to step 302, dataflow analysis module 202 receives as input application binaries of applications and respective sets of function identifiers (i.e., sets of function names) included in the applications. Dataflow analysis module 202 generates intermediate representations (IRs) of the application binaries. In step 302, using the IRs, dataflow analysis module 202 extracts functions included in the application binaries.

In step 304, dataflow analysis module 202 generates respective dataflows for the functions extracted in step 302.

In step 306, dataflow analysis module 202 generates respective dataflow graphs for the dataflows generated in step 304.

In step 308, embedding generation module 204 converts the dataflow graphs generated in step 306 into respective sets of embeddings. The techniques disclosed herein for creating a dataflow-based function signature are based on a finding that similar functions have similar dataflows, which result in similar graph embeddings. This finding is supported by results provided in table 700 in FIG. 7, as described below.

In step 310, knowledge base generation module 206 populates a knowledge base in a data repository with the sets of embeddings converted from the dataflow graphs in step 308. Using embeddings to represent the dataflow graph in the knowledge base facilitates faster searches and optimizes storage. In one embodiment, the data repository that includes the knowledge base is included in storage 124, or is included in or operatively coupled to end user device 103, remote server 104, public cloud 105, or private cloud 106. Alternatively, the aforementioned data repository is not shown in FIG. 1, but is operatively coupled to computer 101.

In step 312, using a first similarity function, a second similarity function, and the knowledge base populated in step 310, similarity module 208 receives a new unlabeled application binary with symbols, processes the new unlabeled application binary using dataflow analysis module 202 and embedding generation module 204 as described above relative to FIG. 2, and determines that the unlabeled application binary matches one of the application binaries by matching the sets of embeddings of the unlabeled application binary with sets of embeddings that populate the knowledge base. In one embodiment, similarity module 208 uses the knowledge base to identify functions that implement operations that are similar across multiple executables.

Following step 312, the process of FIG. 3 ends at an end node 314.

In one embodiment, steps 302 through 310 comprise a first phase of creating and using dataflow-based function signatures and step 312 comprises a second phase of creating and using dataflow-based function signatures. The first phase includes analyzing application binaries to create the knowledge base. The first phase also includes extracting functions from application binaries and creating a dataflow representation for each extracted function. The first phase also includes adding the dataflow representations to a centralized knowledge base. The second phase includes receiving an unlabeled application binary with symbols, extracting functions included in the unlabeled application binary by using an IR of the application binary, generating dataflows for the extracted functions, generating dataflow graphs for the dataflows, and converting the dataflow graphs into sets of embeddings. The second phase also includes analyzing the sets of embeddings associated with the unlabeled application binary for similarities with the sets of embeddings previously stored in the knowledge base during the first phase. The aforementioned first and second similarity functions are devised based on the ground truth and the knowledge base is queried to search for similarities to the sets of embeddings associated with the unlabeled application binary.

FIG. 4 is an example 400 of generating dataflow graphs in the process of FIG. 3, in accordance with embodiments of the present invention. Example 400 includes dataflow module 202 receiving an application binary 402 and identifying or extracting N functions (i.e., function 404-1, . . . , function 404-N) from application binary 402, where N is an integer greater than or equal to one. Dataflow analysis module 202 generates N dataflow graphs 408-1, . . . , 408-N, as respective representations of functions 404-1, . . . , 404-N. Example 400 can be an illustration of a processing by dataflow analysis module 202 of one of the application binaries in steps 302, 304, and 306 in FIG. 3. Alternatively, example 400 can be an illustration of a processing by dataflow analysis module 202 of a new unlabeled application binary prior to being determined in step 312 as being a match to one of the application binaries whose sets of embeddings populate the knowledge base.

FIG. 5 is an example 500 of converting a dataflow graph into a set of embeddings in the process of FIG. 3, in accordance with embodiments of the present invention. Example 500 includes a dataflow graph 502 being input into an embedding algorithm 504, which is employed by embedding generation module 204. Dataflow graph 502 includes nodes labeled “1,” “2,” “3,” and “4” and edges labeled “a,”, “b,” and “c.” Based on the input of the dataflow graph 502, embedding algorithm 504 outputs a set of embeddings 506, thus completing a conversion of dataflow graph 502 into the set of embeddings 506, which is included in step 308 in FIG. 3. Alternatively, the conversion of dataflow graph 502 into set of embeddings 506 by embedding algorithm 504 can be an illustration of a conversion of the dataflow graph representation of the unlabeled application binary being processed in step 312 in FIG. 3.

The set of embeddings 506 includes representations of the edges and nodes included in dataflow graph 502. For example, the first row in set of embeddings 506 is a representation of the nodes labeled “1” because the first element in the first row is labeled with “[1].” Similarly, the second row in the set of embeddings 506 is a representation of the nodes labeled “2,” the third row in the set of embeddings 506 is a representation of the node labeled “3,” . . . , and the seventh row in the set of embeddings 506 is a representation of the edges labeled “c.”

FIG. 6 is an example 600 of determining a measurement of similarity between functions by using a first similarity function in the process of FIG. 3, in accordance with embodiments of the present invention. Example 600 includes a dataflow graph 602 and a dataflow graph 604. Similarity module 208 generates dataflow graph 602 as a representation of a function included in an unlabeled application binary which was received by similarity module 208 and is being processed by similarity module 208 to identify the application binaries whose sets of embeddings populate the knowledge base that are similar or dissimilar to the unlabeled application binary. During a search of the knowledge base, similarity module 208 retrieves a set of embeddings corresponding to dataflow graph 604.

Similarity module 208 determines counts 606 from dataflow graph 602. Counts 606 includes counts of the numbers of edges for the edge IDs (i.e., “a,” “b,” and “c”) in dataflow graph 602 and counts of the numbers of nodes for the node IDs (i.e., “1,” “2,” “3,” and “4”) in dataflow graph 602. For example, [a]=4 in counts 606 indicates that there is a count of four edges labeled “a” in dataflow graph 602.

Similarity module 208 determines counts 608 from dataflow graph 604. Counts 608 includes counts of the numbers of edges for the edge IDs (i.e., “a,” “b,” “c,” and “d”) in dataflow graph 604 and counts of the numbers of nodes for the node IDs (i.e., “1,” “2,” “3,” “4,” and “5”) in dataflow graph 604. For example, [d]=1 in counts 608 indicates that there is a count of one edge labeled “d” in dataflow graph 604. Counts 606 and 608 are input into a first similarity function 610, which is employed by similarity module 208 to calculate a distance 612, which measures a distance between the functions represented by dataflow graphs 602 and 604. In this case, first similarity function 610 calculates a Jaccard distance by calculating one minus the Jaccard similarity measurement based on counts 606 and counts 608. First similarity function 610 calculates the Jaccard similarity measurement as the number of common elements between dataflow graph 602 and dataflow graph 604 divided by the total number of unique elements in the union of elements in dataflow graph 602 and dataflow graph 604. The Jaccard similarity measurement is 14 common elements divided by 19 total unique elements, which is 14/19=0.74, and therefore the Jaccard distance is 1-0.74, which equals 0.26, as indicated in distance 612. The determination of counts 606 and counts 608 and the calculation of the Jaccard similarity measurement and the Jaccard distance by the first similarity function 610 are included in step 312 in FIG. 3. Similarity module 208 determines that the distance of 0.26 does not exceed a predefined threshold similarity measurement for indicating dissimilarity, and therefore similarity module 208 places representations of dataflow graph 604 in a subset of the knowledge graph. Subsequently, the similarity module 208 employs the second similarity function (which provides a similarity measurement that is finer-grained than the similarity measurement of the first similarity function) to determine whether dataflow graph 602 is similar to dataflow graph 604 based on the representations of dataflow graph 604 being included in the subset of the knowledge graph.

FIG. 7 is a table of sample measurements of distances between functions using different compiler optimization levels, where the distances are determined by using a similarity function used in the process of FIG. 3, in accordance with embodiments of the present invention. Table 700 includes a set of functions 702 (i.e., Init functions for four different compiler optimization levels labeled “0,” “1,” “2,” and “3,”), a first set of distance measurements 704, a second set of distance measurements 706, and a third set of distance measurements 708. Table 700 also includes rows and columns referencing functions other than Init functions (i.e., Update functions and Final functions). The distance measurements in table 700 are Jaccard distances. First set of distance measurements 704 includes only distance measurements that are greater than or equal to a dissimilarity threshold value (i.e., a first predefined threshold) that indicates dissimilarity between functions. For example, the distance measurement of 0.9 in the first set of distance measurements 704 in the Init 0 row and the Update 1 column indicates that the Update function using compiler optimization level 1 is dissimilar to the Init function using compiler optimization level 0 because 0.9 is greater than or equal to a threshold value of 0.8.

Second set of measurements 706 includes only distance measurements that are less than or equal to a similarity threshold value (i.e., a second predefined threshold) that indicates similarity between functions. For example, the distance measurement of 0.512 in the second set of distance measurements 706 in the Init 0 row and the Init 1 column indicates that the Init function using the compiler optimization level 1 is similar to the Init function using the compiler optimization level 0 because 0.512 is less than or equal to a similarity threshold value of 0.6. Third set of distance measurements 708 includes only one distance measurement (i.e., 0.744) between Init function using compiler optimization 3 and Init function using compiler optimization level 0, which does not indicate a similarity because 0.744 is greater than the similarity threshold value of 0.6 and does not indicate a dissimilarity because 0.744 is less than the dissimilarity threshold value of 0.8.

Table 700 generally illustrates Jaccard distances that indicate that the Init functions being considered are the same or at least somewhat similar, based on the relatively low values in the second and third sets of distance measurements 706 and 708, while being significantly different from the other functions Update and Final, based on the relatively high values in the first set of distance measurements 704.

The descriptions of the various embodiments of the present invention have been presented herein for purposes of illustration but are not intended to be exhaustive or limited to the embodiments disclosed. Many modifications and variations will be apparent to those or ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system comprising:
one or more computer processors;
one or more computer readable storage media; and
computer readable code stored collectively in the one or more computer readable storage media, with the computer readable code including data and instructions to cause the one or more computer processors to perform at least the following operations:
using intermediate representations of application binaries of respective applications, extracting functions included in the application binaries;
generating dataflows for the extracted functions, respectively;
generating dataflow graphs for the generated dataflows, respectively;
converting the dataflow graphs into respective sets of embeddings;
populating a knowledge base in a data repository with the sets of embeddings; and
using a first similarity function, a second similarity function, and the populated knowledge base, determining that an unlabeled application binary matches one of the application binaries.

2. The computer system of claim 1, wherein the computer readable code including the data and the instructions causes the one or more computer processors to perform the determining that the unlabeled application binary matches one of the application binaries by performing at least the following operations:
using the first similarity function, determining measurements of similarity between (i) sets of embeddings associated with an entirety of functions included in the unlabeled application binary and (ii) a set of embeddings included in the populated knowledge base;
determining that each of the measurements of similarity does not exceed a threshold similarity measurement; and
based on each of the measurements of similarity not exceeding the threshold similarity measurement, designating the set of embeddings included in the populated knowledge base as being dissimilar to each of the sets of embeddings associated with the entirety of functions included in the unlabeled application binary and preventing the designated set of embeddings included in the populated knowledge base from being placed in a subset of the populated knowledge base and from being further processed in an application of the second similarity function, which provides measurements of similarity between the unlabeled application binary and application binaries associated with sets of embeddings included in the subset of the populated knowledge base.

3. The computer system of claim 1, wherein the computer readable code including the data and the instructions causes the one or more computer processors to perform the determining that the unlabeled application binary matches one of the application binaries by performing at least the following operations:
using the first similarity function, determining a measurement of similarity between (i) a set of embeddings associated with a function included in the unlabeled application binary and (ii) a set of embeddings included in the populated knowledge base;
determining that a measurement of similarity exceeds a threshold similarity measurement; and
based on the measurement of similarity exceeding the threshold similarity measurement, designating the set of embeddings included in the populated knowledge base as being similar to the set of embeddings associated with the function included in the unlabeled application binary and placing the designated set of embeddings included in the populated knowledge base into a subset of the populated knowledge base, the subset of the populated knowledge base being permitted to be further processed in an application of the second similarity function, which provides measurements of similarity between the unlabeled application binary and application binaries associated with sets of embeddings included in the subset of the populated knowledge base.

4. The computer system of claim 1, wherein the computer readable code including data and instructions causes the one or more computer processors to perform at least the following further operation:
capturing information about a structure of a given dataflow graph included in the generated dataflow graphs while ignoring identifiers of nodes and identifiers of edges in the given dataflow graph, wherein the capturing the information includes capturing types of the nodes, types of the edges, total numbers of nodes of one or more of the types of the nodes, and total numbers of edges of one or more of the types of the edges, and wherein the converting the dataflow graphs is based on the captured information about the structure of the given dataflow.

5. The computer system of claim 1, wherein the computer readable code including data and instructions causes the one or more computer processors to perform at least the following further operation:
capturing information about a structure of a given dataflow graph included in the generated dataflow graphs by generating, in a pattern rather than in a random order, identifiers of nodes and identifiers of edges in the given dataflow graph, wherein the capturing the information includes capturing type information about a head node and a tail node for a given edge included in the edges in the given dataflow graph and associating the type information about the head and tail nodes with a type of the given edge, and wherein the converting the dataflow graphs is based on the captured information about the structure of the given dataflow.

6. The computer system of claim 1, wherein the first similarity function determines similarity measurements by employing a Jaccard distance and the second similarity function determines similarity measurements by employing a distance selected from the group consisting of a cosine distance, an L2-norm Euclidean distance, an L1-norm Manhattan distance, a dot product distance, and an extended Jaccard distance.

7. The computer system of claim 1, wherein the computer readable code including data and instructions causes the one or more computer processors to perform at least the following further operation:
using a given set of embeddings converted from a given dataflow graph generated for a given dataflow for a given function, generating a dataflow-based signature of the given function, wherein the given dataflow specifies data flowing into variables and registers and being passed to and returned from other functions.

8. A computer program product comprising:
one or more computer readable storage media having computer readable program code collectively stored on the one or more computer readable storage media, the computer readable program code being executed by one or more processors of a computer system to cause the computer system to perform at least the following operations:
using intermediate representations of application binaries of respective applications, extracting functions included in the application binaries;
generating dataflows for the extracted functions, respectively;
generating dataflow graphs for the generated dataflows, respectively;
converting the dataflow graphs into respective sets of embeddings;
populating a knowledge base in a data repository with the sets of embeddings; and
using a first similarity function, a second similarity function, and the populated knowledge base, determining that an unlabeled application binary matches one of the application binaries.

9. The computer program product of claim 8, wherein the computer readable program code being executed by the one or more processors of the computer system causes the computer system to perform the determining that the unlabeled application binary matches one of the application binaries by performing at least the following operations:
using the first similarity function, determining measurements of similarity between (i) sets of embeddings associated with an entirety of functions included in the unlabeled application binary and (ii) a set of embeddings included in the populated knowledge base;
determining that each of the measurements of similarity does not exceed a threshold similarity measurement; and
based on each of the measurements of similarity not exceeding the threshold similarity measurement, designating the set of embeddings included in the populated knowledge base as being dissimilar to each of the sets of embeddings associated with the entirety of functions included in the unlabeled application binary and preventing the designated set of embeddings included in the populated knowledge base from being placed in a subset of the populated knowledge base and from being further processed in an application of the second similarity function, which provides measurements of similarity between the unlabeled application binary and application binaries associated with sets of embeddings included in the subset of the populated knowledge base.

10. The computer program product of claim 8, wherein the computer readable program code being executed by the one or more processors of the computer system causes the computer system to perform the determining that the unlabeled application binary matches one of the application binaries by performing at least the following operations:
using the first similarity function, determining a measurement of similarity between (i) a set of embeddings associated with a function included in the unlabeled application binary and (ii) a set of embeddings included in the populated knowledge base;
determining that a measurement of similarity exceeds a threshold similarity measurement; and
based on the measurement of similarity exceeding the threshold similarity measurement, designating the set of embeddings included in the populated knowledge base as being similar to the set of embeddings associated with the function included in the unlabeled application binary and placing the designated set of embeddings included in the populated knowledge base into a subset of the populated knowledge base, the subset of the populated knowledge base being permitted to be further processed in an application of the second similarity function, which provides measurements of similarity between the unlabeled application binary and application binaries associated with sets of embeddings included in the subset of the populated knowledge base.

11. The computer program product of claim 8, wherein the computer readable program code being executed by one or more processors of a computer system causes the computer system to perform at least the following operation:
capturing information about a structure of a given dataflow graph included in the generated dataflow graphs while ignoring identifiers of nodes and identifiers of edges in the given dataflow graph, wherein the capturing the information includes capturing types of the nodes, types of the edges, total numbers of nodes of one or more of the types of the nodes, and total numbers of edges of one or more of the types of the edges, and wherein the converting the dataflow graphs is based on the captured information about the structure of the given dataflow.

12. The computer program product of claim 8, wherein the computer readable program code being executed by one or more processors of a computer system causes the computer system to perform at least the following operation:
capturing information about a structure of a given dataflow graph included in the generated dataflow graphs by generating, in a pattern rather than in a random order, identifiers of nodes and identifiers of edges in the given dataflow graph, wherein the capturing the information includes capturing type information about a head node and a tail node for a given edge included in the edges in the given dataflow graph and associating the type information about the head and tail nodes with a type of the given edge, and wherein the converting the dataflow graphs is based on the captured information about the structure of the given dataflow.

13. The computer program product of claim 8, wherein the first similarity function determines similarity measurements by employing a Jaccard distance and the second similarity function determines similarity measurements by employing a distance selected from the group consisting of a cosine distance, an L2-norm Euclidean distance, an L1-norm Manhattan distance, a dot product distance, and an extended Jaccard distance.

14. The computer program product of claim 8, wherein the computer readable program code being executed by one or more processors of a computer system causes the computer system to perform at least the following operation:
using a given set of embeddings converted from a given dataflow graph generated for a given dataflow for a given function, generating a dataflow-based signature of the given function, wherein the given dataflow specifies data flowing into variables and registers and being passed to and returned from other functions.

15. A computer-implemented method comprising:
using intermediate representations of application binaries of respective applications, extracting, by one or more processors, functions included in the application binaries;
generating, by the one or more processors, dataflows for the extracted functions, respectively;
generating, by the one or more processors, dataflow graphs for the generated dataflows, respectively;
converting, by the one or more processors, the dataflow graphs into respective sets of embeddings;
populating, by the one or more processors, a knowledge base in a data repository with the sets of embeddings; and
using a first similarity function, a second similarity function, and the populated knowledge base, determining, by the one or more processors, that an unlabeled application binary matches one of the application binaries.

16. The method of claim 15, wherein the determining that the unlabeled application binary matches one of the application binaries comprises:
using the first similarity function, determining, by the one or more processors, measurements of similarity between (i) sets of embeddings associated with an entirety of functions included in the unlabeled application binary and (ii) a set of embeddings included in the populated knowledge base;
determining, by the one or more processors, that each of the measurements of similarity does not exceed a threshold similarity measurement; and
based on each of the measurements of similarity not exceeding the threshold similarity measurement, designating, by the one or more processors, the set of embeddings included in the populated knowledge base as being dissimilar to each of the sets of embeddings associated with the entirety of functions included in the unlabeled application binary and preventing, by the one or more processors, the designated set of embeddings included in the populated knowledge base from being placed in a subset of the populated knowledge base and from being further processed in an application of the second similarity function, which provides measurements of similarity between the unlabeled application binary and application binaries associated with sets of embeddings included in the subset of the populated knowledge base.

17. The method of claim 15, wherein the determining that the unlabeled application binary matches one of the received application binaries comprises:
using the first similarity function, determining, by the one or more processors, a measurement of similarity between (i) a set of embeddings associated with a function included in the unlabeled application binary and (ii) a set of embeddings included in the populated knowledge base;
determining, by the one or more processors, that a measurement of similarity exceeds a threshold similarity measurement; and
based on the measurement of similarity exceeding the threshold similarity measurement, designating, by the one or more processors, the set of embeddings included in the populated knowledge base as being similar to the set of embeddings associated with the function included in the unlabeled application binary and placing, by the one or more processors, the designated set of embeddings included in the populated knowledge base into a subset of the populated knowledge base, the subset of the populated knowledge base being permitted to be further processed in an application of the second similarity function, which provides measurements of similarity between the unlabeled application binary and application binaries associated with sets of embeddings included in the subset of the populated knowledge base.

18. The method of claim 15, further comprising:
capturing, by the one or more processors, information about a structure of a given dataflow graph included in the generated dataflow graphs while ignoring identifiers of nodes and identifiers of edges in the given dataflow graph, wherein the capturing the information includes capturing types of the nodes, types of the edges, total numbers of nodes of one or more of the types of the nodes, and total numbers of edges of one or more of the types of the edges, and wherein the converting the dataflow graphs is based on the captured information about the structure of the given dataflow.

19. The method of claim 15, further comprising:
capturing, by the one or more processors, information about a structure of a given dataflow graph included in the generated dataflow graphs by generating, in a pattern rather than in a random order, identifiers of nodes and identifiers of edges in the given dataflow graph, wherein the capturing the information includes capturing type information about a head node and a tail node for a given edge included in the edges in the given dataflow graph and associating the type information about the head and tail nodes with a type of the given edge, and wherein the converting the dataflow graphs is based on the captured information about the structure of the given dataflow.

20. The method of claim 15, wherein the first similarity function determines similarity measurements by employing a Jaccard distance and the second similarity function determines similarity measurements by employing a distance selected from the group consisting of a cosine distance, an L2-norm Euclidean distance, an L1-norm Manhattan distance, a dot product distance, and an extended Jaccard distance.
